(19) United States
(12) Patent Application Publication
(10) Pub. No.: US 2026/0364524 A1
(43) Pub. Date: Nov. 19, 2026

(54) ACID GAS REMOVAL IN OXY-FUEL COMBUSTION

(71) Applicant: NET Power LLC, Durham, NC (US)

(72) Inventors: Xijia Lu, Salt Lake City, UT (US); Sashank Kasiraju, Cary, NC (US)

(73) Assignee: NET Power LLC, Durham, NC (US)

(21) Appl. No.: 19/544,589

(22) Filed: Feb. 19, 2026

Related U.S. Application Data
(60) Provisional application No. 63/761,644, filed on Feb. 21, 2025.

(51) Int. Cl. B01D 53/14; B01D 53/00; B01D 53/26

(52) U.S. Cl. CPC B01D 53/1493; B01D 53/005; B01D 53/1412; B01D 53/1425; B01D 53/145; B01D 53/1456; B01D 53/26; B01D 2256/22; B01D 2257/602; B01D 2258/0283

(57) ABSTRACT

Methods and systems for removing an acid gas from a flue gas stream are disclosed. The flue gas stream, consisting of an acid gas and an oxidant, are injected into a water scrubber, where they react to oxidize the acid gas, combining with water to form an acidic water stream, which is passed out of the water scrubber while the stripped flue gas stream is deoxygenated to produce a carbon dioxide product stream. The carbon dioxide product stream is dehydrated and the makeup water recycled. Heat from the deoxygenation trim heats the water stream and creates steam.

### CROSS-REFERENCE TO RELATED APPLICATIONS

This application claims the benefit of U.S. Provisional Patent Application No. 63/761,644, filed Feb. 21, 2025 and entitled “Acid Gas Removal in Oxy-Fuel Combustion,” the entire contents of which are incorporated by reference herein.

### TECHNICAL FIELD

The present disclosure relates to systems and methods for removing an acid gas from a flue stream, for example in oxy-fuel combustion systems.

### BACKGROUND

Combustion systems, including the Allam Cycle, may utilize a carbonaceous fuel, an oxidant stream, and a recycled carbon dioxide stream to produce energy. The oxidant and recycle streams require energy inputs to produce. For certain details of the Allam Cycle, see U.S. Pat. No. 8,596,075, the entire contents of which are incorporated by reference herein.

### SUMMARY

In some examples, the present disclosure provides a method for removing an acid gas from a flue gas stream, the flue gas stream comprising an acid gas, an oxidant, and carbon dioxide. The method includes injecting the flue gas stream into a water scrubber. The method includes dissolving the acid gas and the oxidant into the water stream. The method includes reacting the acid gas and the oxidant in the water such that the oxidant oxidizes the acid gas, generating an acidic water stream and a stripped flue gas stream. The method includes passing the acidic water stream out of the water scrubber. The method includes passing the stripped flue gas stream out of the water scrubber. The method includes deoxygenating the stripped flue gas stream to produce a carbon dioxide product stream. The method includes cooling the carbon dioxide product stream by trim heating the water stream and by generating steam. The method includes dehydrating the carbon dioxide product stream to produce a dry carbon dioxide product stream and a makeup water stream. The method includes passing the makeup water stream to the water scrubber as part of the water stream.

In some examples, the method includes injecting an additional oxidant stream into the water scrubber to react with the acid gas.

In some examples, the oxidant is oxygen and the additional oxidant is selected from the group consisting of oxygen, hydrogen peroxide, ozone, NaOCl, and combinations thereof.

In some examples, the method includes detecting oxygen partial pressure in the carbon dioxide product stream and controlling addition of the additional oxidant to keep the detected oxygen partial pressure below a limit.

In some examples, the flue gas consists of mercury, mercury oxides, or both, and the method further includes removing the mercury, mercury oxides, or both from the flue gas stream before injection into the water scrubber.

In some examples, the method includes cooling the carbon dioxide product stream before dehydration with a cold fluid from an air separation unit or a cooling tower from an oxy-fuel combustion plant.

In some examples, the acid gas is selected from the group consisting of NO, NO₂, SO₂, SO₃, and combinations thereof.

In some examples, the stripped flue gas stream has less than about 1 ppm nitrogen oxides.

In some examples, the stripped flue gas stream has less than about 1 ppm sulfur oxides.

In some examples, the carbon dioxide product stream has less than about 10 ppm oxidant.

In some examples, the method includes deoxygenating at a temperature lower than a temperature that produces nitrogen oxides.

In some examples, the water scrubber includes a series of water scrubbers.

In some examples, the water scrubber includes a countercurrent packed bed spray tower.

In some examples, the method includes bubbling the flue gas stream into the water scrubber. In some examples, the method includes agitating the water scrubber.

In some examples, the flue gas stream is at a pressure between about 30 bar and about 60 bar.

In some examples, the flue gas stream is from an amine scrubbing plant. The method includes passing the steam to regeneration in the amine scrubbing plant.

In some examples, the method includes heating the stripped flue gas stream before deoxygenation with heat from an oxy-fuel combustion plant.

In some examples, the method includes creating the flue gas stream in an oxy-fuel combustion system.

In some examples, the method includes processing the acid water stream to recover water for use as a portion of the water stream and to produce an acid product stream.

In some examples, the method includes neutralizing the acid product stream.

In some examples, the method includes controlling the pH of the water stream.

In some examples, the disclosure provides a method for removing an acid gas from a flue gas stream, the flue gas stream consisting of an acid gas and carbon dioxide.

In some examples, the flue gas stream is sourced from a coal power plant or a cement plant, and the method further includes filtering out particulates and heavy metals from the flue gas stream before water scrubbing.

The method includes injecting the flue gas stream and an oxidant stream into a water scrubber. The method includes dissolving the acid gas into the water stream. The method includes reacting the acid gas and the oxidant in the water such that the oxidant oxidizes the acid gas, generating an acidic water stream and a stripped flue gas stream. The method includes passing the acidic water stream out of the water scrubber. The method includes passing the stripped flue gas stream out of the water scrubber. The method includes deoxygenating the stripped flue gas stream to produce a carbon dioxide product stream. The method includes cooling the carbon dioxide product stream by trim heating the water stream and by generating steam. The method includes dehydrating the carbon dioxide product stream to produce a dry carbon dioxide product stream and a makeup water stream. The method includes passing the makeup water stream to the water scrubber as part of the water stream.

In some examples, the disclosure provides a system for removing an acid gas from a flue gas stream, the flue gas stream including an acid gas, an oxidant, and carbon dioxide. The system includes a water scrubber to dissolve the acid gas and the oxidant into a water stream, react the acid gas and the oxidant in the water such that the oxidant oxidizes the acid gas to generate an acidic water stream and a stripped flue gas stream, pass the acid water stream out of the water scrubber, and pass the stripped flue gas stream out of the water scrubber. The system includes a deoxygenation unit to deoxygenate the stripped flue gas stream to produce a carbon dioxide product stream. The system includes a first heat exchanger to cool the carbon dioxide product stream by trim heating the water steam. The system includes a second heat exchanger to further cool the carbon dioxide product stream by creating steam. The system includes a dehydrator to dehydrate the carbon dioxide product stream to produce a dry carbon dioxide product stream and a makeup water stream and to pass the makeup water stream to the water scrubber as makeup for the water stream.

In some examples, the system includes an oxidant production unit to inject an additional oxidant into the water scrubber to react with the acid gas.

In some examples, the oxidant is oxygen and the additional oxidant is selected from the group consisting of oxygen, hydrogen peroxide, ozone, NaOCl, and combinations thereof.

In some examples, the system includes an oxygen detector to detect oxygen partial pressure in the carbon dioxide stream and to control the addition of the additional oxidant to keep the detected oxygen partial pressure below a limit.

In some examples, the dehydrator is a molecular sieve.

In some examples, the flue gas includes mercury, mercury oxides, or both, and the system further includes a mercury scrubber to remove the mercury, mercury oxides, or both from the flue gas stream before the water scrubber.

In some examples, the system includes a heat exchanger to cool the carbon dioxide product stream before the dehydrator with a cold fluid from an air separation unit or cooling water from an oxy-fuel combustion plant.

In some examples, the acid gas is selected from the group consisting of NO, NO₂, SO₂, SO₃, and combinations thereof.

In some examples, the stripped flue gas stream has less than about 1 ppm nitrogen oxides.

In some examples, the stripped flue gas stream has less than about 1 ppm sulfur oxides.

In some examples, the carbon dioxide product stream has less than about 10 ppm oxidant.

In some examples, the deoxygenation unit further operates at a temperature lower than a temperature that produces nitrogen oxides.

In some examples, the water scrubber includes a series of water scrubbers.

In some examples, the water scrubber includes a countercurrent packed bed spray tower.

In some examples, the water scrubber includes a bubbler to disperse the flue gas stream into the water scrubber.

In some examples, the water scrubber further includes an agitator to agitate the water stream.

In some examples, the flue gas stream is at a pressure between about 30 bar and about 60 bar.

In some examples, the system includes an amine scrubber to scrub amines from the flue gas stream before the water scrubber.

In some examples, the system includes a steam regeneration unit in the amine scrubbing plant to receive the steam.

In some examples, the system includes an oxy-fuel combustion plant to provide a heating fluid to heat the stripped flue gas stream before the deoxygenation unit.

In some examples, the system includes an oxy-fuel combustion plant to create the flue gas stream.

In some examples, the system includes an acid removal unit to recover water from the acid water stream and produce an acid product stream.

In some examples, the system includes a neutralizer unit to neutralize the acid product stream.

In some examples, the system includes a pH controller to control the pH of the water stream.

In some examples, the flue gas stream is sourced from a coal power plant or a cement plant, the system further including a filter to remove particulates and heavy metals from the flue gas stream before the water scrubber.

In some examples, the disclosure provides a system for removing an acid gas from a flue gas stream, the flue gas stream consisting of an acid gas and carbon dioxide. The system includes a water scrubber to dissolve the acid gas and an oxidant stream into a water stream, react the acid gas and the oxidant in the water such that the oxidant oxidizes the acid gas to a highest oxidation state to generate an acidic water stream and a stripped flue gas stream, pass the acid water stream out of the water scrubber, and pass the stripped flue gas stream out of the water scrubber. The system includes a deoxygenation unit to deoxygenate the stripped flue gas stream to produce a carbon dioxide product stream. The system includes a first heat exchanger to cool the carbon dioxide product stream by trim heating the water steam. The system includes a second heat exchanger to further cool the carbon dioxide product stream by creating steam. The system includes a dehydrator to dehydrate the carbon dioxide product stream to produce a dry carbon dioxide product stream and a makeup water stream and to pass the makeup water stream to the water scrubber as makeup for the water stream.

In some examples, the flue gas stream further includes a second oxidant.

Further examples are provided in the drawings, detailed description, and claims.

### BRIEF DESCRIPTION OF DRAWINGS

The following drawings are provided to illustrate certain embodiments described herein. The drawings are merely illustrative and are not intended to limit the scope of the claims and are not intended to show every potential feature or embodiment that is claimed. The drawings are not necessarily drawn to scale; in some instances, certain elements of the drawing may be enlarged with respect to other elements of the drawing for purposes of illustration.

FIG. 1 is a process diagram showing a system for removing an acid gas from a flue gas stream.

FIG. 2 is a process diagram showing a system for removing an acid gas from a flue gas stream.

FIG. 3 is a block diagram showing a method for removing an acid gas from a flue gas stream.

### DETAILED DESCRIPTION

The following description recites various aspects and embodiments of the subject matter disclosed herein. No particular embodiment is intended to define the scope of the present subject matter. Rather, the embodiments provide non-limiting examples of various compositions, and methods that are included within the scope of the claimed subject matter. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “about” means within ±10% of the stated value, e.g., within ±5% of the stated value, or within ±2% of the stated value.

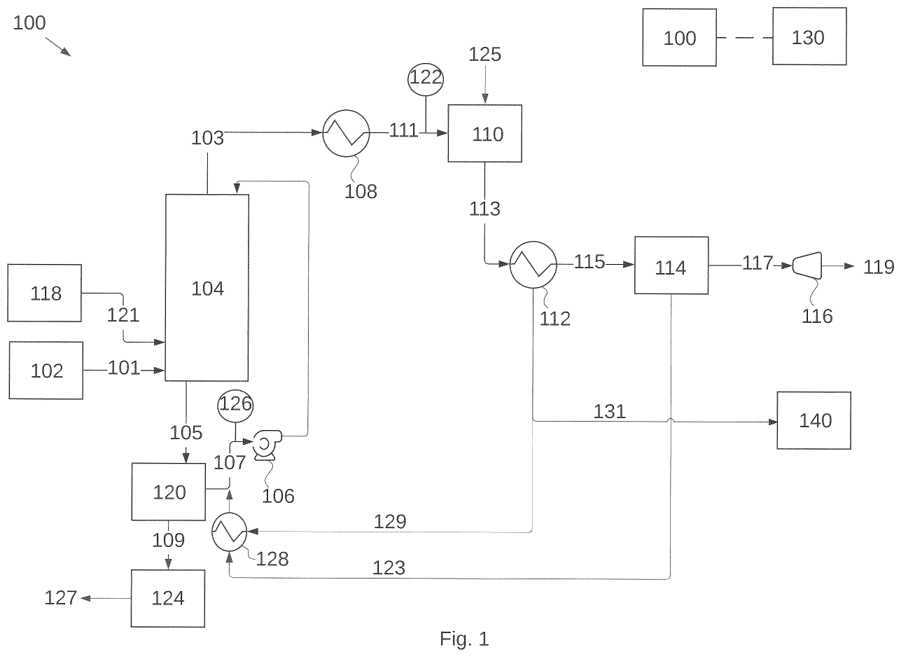

FIG. 1 is a process diagram showing a system for removing an acid gas from a flue gas stream that may be used in some examples provided herein. This example is purely illustrative, and multiple other examples are envisioned or may be readily envisioned without undue experimentation.

In some examples, system 100 is a scrubbing system for removing acid gas from flue gas. In the nonlimiting configuration illustrated in FIG. 1, system 100 includes a flue gas source 102, a water scrubber 104, a recirculating pump 106, a first heat exchanger 108, a deoxygenator 110, a second heat exchanger 112, a dehydrator 114, a compressor 116, an oxygen production unit 118, an acid treatment unit 120, an O₂ sensor 122, an acid neutralizer unit 124, a pH meter 126, a heat exchanger 128, a controller 130, and a steam generation unit 140.

Controller 130 may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller 130 and the system 100 may be implemented using any suitable combination of hardware and software.

In the present example, the flue gas source 102 is an oxy-fuel combustion system. In other examples, other combustion systems or other flue gas sources may be used. The source 102 produces a flue gas stream 101 that consists of at least carbon dioxide, acid gases, and an oxidant. In this example, the acid gases include SO₂, SO₃, NO, and NO₂. In this example, the oxidant is leftover oxygen from the oxy-fuel combustion reaction. A second oxidant stream 121 is produced from the oxidant production unit 118. In this example, the oxidant is also oxygen and is provided in sufficient stoichiometric ratio to allow complete oxidation of the acid gases. In some examples, stream 121 would have no flow, when the oxidant in stream 101 is sufficient.

Streams 101 and 121 are injected into water scrubber 104 and at least a portion of the acid gases and the oxygen are dissolved in a descending water stream 107. Stream 107 is supplemented by makeup water 123. The acid gases thus dissolved react with the oxidant and water, in this example oxygen, to produce H₂SO₄ and HNO₃ in the water stream. The flue gas stream 103, without acid gases and with minimal oxygen is passed out of the scrubber 104 and heated in heat exchanger 108. In some embodiments, this heat is provided from heat sources in the oxy-fuel combustion plant. In some embodiments, this heat is provided from stream 113.

The flue gas stream 111 is passed into the deoxygenation unit 110 where fuel gas 125 is combusted with any leftover oxygen. Oxygen detector 122 in the feed to the deoxygenation unit provides partial pressure data to the controller 130 to control the amount of fuel gas 125 injected to balance fuel gas usage to oxygen present and keep the final product oxygen partial pressure below a limit. The resultant deoxygenated flue gas stream 113 is then cooled in exchanger 112 to condense out at least a portion of any water present in the stream and then dehydrated in dehydration unit 114 to produce a dehydrated carbon dioxide product gas stream 117. The dehydration unit 114 in this example would be a molecular sieve. Stream 117 is compressed in a compressor 116 and product carbon dioxide stream 119 is sent to a pipeline for sale.

The heat from stream 113 can be used directly or indirectly. In the present example, it is used indirectly through heat exchanger 112. The heat exchange fluid leaves exchanger 112 and splits as streams 129 and 131. Stream 129 is used in exchanger 128 to heat makeup water 123, sourced from dehydrator 114. Stream 131 is sent to create steam in steam generation unit 140. In some embodiments, unit 140 is part of an amine scrubbing plant's regeneration unit.

The acidified water stream 105 is passed out of the water scrubber 104 and through the acid treatment unit 120. Treated water is recycled as stream 107 while acid waste 109 is removed. Control of the system is provided by the controller 130 reading pH from pH meter 126 and controlling acid treatment unit 120. Acid waste 109 may be neutralized in neutralizer unit 124, resulting in a neutral stream 127.

In some examples, the flue gas stream is sourced from a coal boiler plant or a cement plant. In these examples, 102 further includes filters to remove particulates and heavy metals.

In some examples, the flue gas stream is sourced from a combustion system with low-grade CO₂, and the CO₂ is upgraded in an amine scrubber, included as part of 102. In some of these examples, the system is at a low pressure and is upgraded to a higher pressure by a compressor in 102.

In some examples, an HC-SCR is included in the deoxygenation system to remove not only O₂ but any lingering trace NOₓ. In these examples, unit 110 includes the combustor and a second scrubber to remove any trace NO₂.

In some examples, there are one or more O₂ sensors before the water scrubber. In some examples, there are NOₓ, SOₓ or both NOₓ and SOₓ sensors before and/or after the water scrubber.

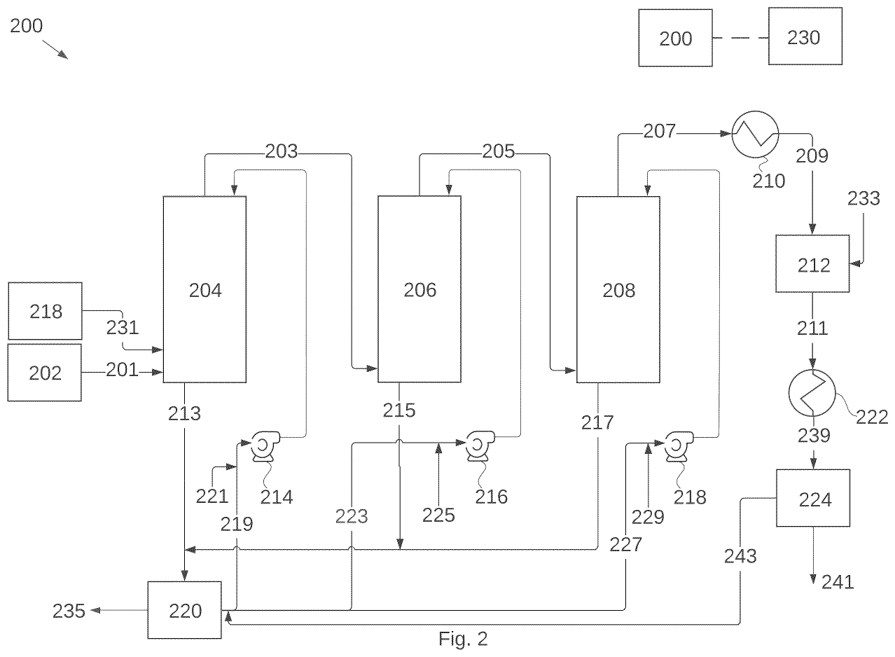

In some examples, multiple scrubbers are used in series, which is explored further in FIG. 2.

Now referring to FIG. 2, FIG. 2 is a process diagram showing a system for removing an acid gas from a flue gas stream that may be used in some examples provided herein. This example is purely illustrative, and multiple other examples are envisioned or may be readily envisioned without undue experimentation.

In some examples, system 200 is a scrubbing system for removing acid gas from flue gas. In the nonlimiting configuration illustrated in FIG. 2, system 200 includes a flue gas source 202, water scrubbers 204, 206, and 208, each with recirculating pumps 214, 216, and 218, a heat exchanger 210, a deoxygenator 212, an oxygen production unit 218, an acid treatment unit 220, a second heat exchanger 222, a dehydration unit 224, and a controller 230.

Controller 230 may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller 230 and the system 200 may be implemented using any suitable combination of hardware and software.

In the present example, the flue gas source 202 is an oxy-fuel combustion system. In other examples, other combustion systems or other flue gas sources may be used. The source 202 produces a flue gas stream 201 that consists of at least carbon dioxide, acid gases, and an oxidant. In other embodiments, the flue gas has no oxidant. In this example, the acid gases include some or all of SO₂, SO₃, NO, and NO₂. In this example, the oxidant is leftover oxygen from the oxy-fuel combustion reaction. A second oxidant stream 231 is produced from the oxidant production unit 218. The oxidant may be or include oxygen, hydrogen peroxide, ozone, NaOCl, and combinations thereof. The oxidant is provided in sufficient stoichiometric ratio to allow complete oxidation of the acid gases. In some examples, stream 231 would have no flow, when the oxidant in stream 201 is sufficient.

Streams 201 and 231 are injected into water scrubber 204 and at least a portion of the acid gases and the oxygen are dissolved in a descending water stream 219. Stream 219 is supplemented by makeup water 221. The acid gases thus dissolved react with the oxidant and water to produce H₂SO₄ and HNO₃ in the water stream. The flue gas stream 203, without acid gases and with minimal oxygen is passed out of the scrubber 204 and is treated again in scrubber 206, producing stream 205, which is treated in scrubber 208, producing a treated flue gas stream 207. Stream 207 is heated in heat exchanger 210, producing stream 209.

Scrubber 206 and scrubber 208 each have water recycle streams 223 and 227 with makeup waters 225 and 229, respectively.

The flue gas stream 209 is passed into the deoxygenation unit 212 where fuel gas 233 is combusted with any leftover oxygen. Oxygen sensors in the feed to the deoxygenation unit provide data to the controller 230 to control the amount of fuel gas 233 injected to balance fuel gas usage to oxygen present. The resultant deoxygenated flue gas stream 211 is cooled in exchanger 222 to produce a cooled gas stream 239 and then dehydrated in dehydrator 224, resulting in a product stream 241. Water recovered from the dehydrator is passed as stream 243 as makeup water. Not shown, heat from exchanger 222 is used to preheat the water for all three scrubbers and also used to generate steam in a separate unit, similar to FIG. 1.

The acidified water streams 213, 215, and 217 are passed out of the water scrubbers 204, 206, and 208 and through the acid treatment unit 220. Treated water is recycled as streams 219, 223, and 227 while acid waste 235 is removed.

In some examples, the system includes a heat exchanger to cool the carbon dioxide product stream before the dehydration unit with a cold fluid from an air separation unit or cooling water from an oxy-fuel combustion plant.

In some examples, the stripped flue gas stream has less than about 1 ppm nitrogen oxides, and less than about 1 ppm sulfur oxides. In some examples, the carbon dioxide product stream has less than about 10 ppm oxidant.

In some examples, the deoxygenation unit further operates at a temperature lower than a temperature that produces nitrogen oxides.

In some examples, the water scrubbers are countercurrent packed bed spray towers. In some examples, the water scrubbers include a bubbler to disperse the flue gas stream into the water scrubber. In some examples, the water scrubbers further include an agitator to agitate the water stream.

In some examples, the flue gas stream is at a pressure between about 30 bar and about 60 bar.

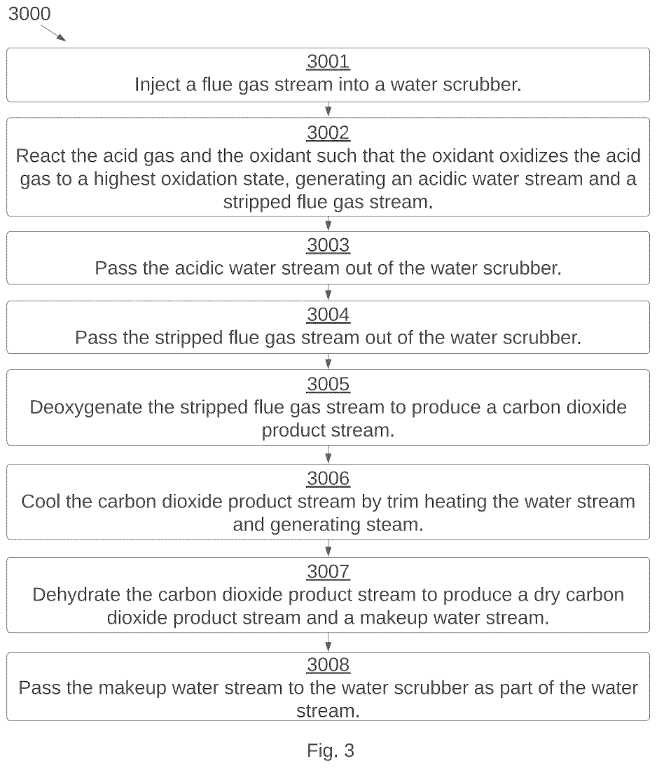

Illustratively, FIG. 3 is a block diagram showing an example method 3000 for removing an acid gas from a flue gas stream that may be used in some examples provided herein. While method 3000 optionally may be implemented using system 100 or 200, it will be appreciated that any other suitable combination of components may be used to implement method 3000.

Method 3000 illustrated in FIG. 3 may include injecting a flue gas stream into a water scrubber (operation 3001). For example, in a manner such as described above with reference to FIG. 1, flue gas stream 101 is injected into a water scrubber 104 and passed through a water stream 107.

Referring again to FIG. 3, method 3000 may also include reacting the acid gas and the oxidant such that the oxidant oxidizes the acid gas to a highest oxidation state, generating an acidic water stream and a stripped flue gas stream (operation 3002). This operation may be performed, for example, in a manner such as described above with reference to FIG. 1, as in water scrubber 104.

Referring again to FIG. 3, method 3000 may also include passing the acidic water stream out of the water scrubber (operation 3003). For example, in a manner such as described above with reference to FIG. 1, acidic water stream 105 is passed out of water scrubber 104.

Referring again to FIG. 3, method 3000 may also include passing the stripped flue gas stream out of the water scrubber (operation 3004). For example, in a manner such as described above with reference to FIG. 1, flue gas stream 103 is passed out of water scrubber 104.

Referring again to FIG. 3, method 3000 may also include deoxygenating the stripped flue gas stream to produce a carbon dioxide product stream (operation 3005). For example, in a manner such as described above with reference to FIG. 1, flue gas stream 103 is pre-heated in exchanger 108 and combusted with flue gas 125 in deoxygenator 110, producing carbon dioxide product stream 113.

Referring again to FIG. 3, method 3000 may also include cooling the carbon dioxide product stream by trim heating the water stream and generating steam (operation 3006). For example, in a manner such as described above with reference to FIG. 1, heating stream 131 used in steam generator 140 and heating stream 129 used in exchanger 128.

Referring again to FIG. 3, method 3000 may also include dehydrating the carbon dioxide product stream to produce a dry carbon dioxide product stream and a makeup water stream (operation 3007). For example, in a manner such as described above with reference to FIG. 1, stream 115 is dehydrated in dehydrator 114, producing carbon dioxide stream 117 and makeup water stream 123.

Referring again to FIG. 3, method 3000 may also include passing the makeup water stream to the water scrubber as part of the water stream (operation 3008). For example, in a manner such as described above with reference to FIG. 1, makeup water stream 123 is passed through heat exchanger 128 and on to join stream 107 as the recycled water into the scrubber 104.

Techniques for catalytic removal of oxygen from gas streams in combustors are generally known in the prior art.

Techniques for dehydration of flue gas streams by molecular sieves or similar are generally known in the prior art.

Techniques for NOx selective catalytic reduction by hydrocarbons (HC-SCR) are generally known in the prior art.

All patents and published patent applications referred to herein are incorporated herein by reference, including US Patent Publication 2018/0133647, U.S. Pat. Nos. 9,919,268, 8,580,206 and EP 0525701. The invention has been described with reference to various specific and preferred embodiments and techniques. Nevertheless, it is understood that many variations and modifications may be made while remaining within the spirit and scope of the invention.

What is claimed is:

1. A method for removing an acid gas from a flue gas stream, the flue gas stream comprising an acid gas, an oxidant, and carbon dioxide, the method comprising:
injecting the flue gas stream into a water stream in a water scrubber;
reacting the acid gas and the oxidant such that the oxidant oxidizes the acid gas, generating an acidic water stream and a stripped flue gas stream;
passing the acidic water stream out of the water scrubber;
passing the stripped flue gas stream out of the water scrubber;
deoxygenating the stripped flue gas stream to produce a carbon dioxide product stream;
cooling the carbon dioxide product stream by trim heating the water stream and by generating steam;
dehydrating the carbon dioxide product stream to produce a dry carbon dioxide product stream and a makeup water stream; and
passing the makeup water stream to the water scrubber as part of the water stream.

2. The method of claim 1, further comprising injecting an additional oxidant stream into the water scrubber to react with the acid gas.

3. The method of claim 2, wherein the oxidant is oxygen and the additional oxidant is selected from the group consisting of oxygen, hydrogen peroxide, ozone, NaOCl, and combinations thereof.

4. The method of claim 2, further comprising detecting oxygen partial pressure in the carbon dioxide product stream and controlling addition of the additional oxidant to keep the detected oxygen partial pressure below a limit.

5. The method of claim 1, wherein the flue gas comprises mercury, mercury oxides, or both, the method further comprising removing the mercury, mercury oxides, or both from the flue gas stream before injection into the water scrubber.

6. The method of claim 1, further comprising cooling the carbon dioxide product stream before dehydration with a cold fluid from an air separation unit or a cooling tower from an oxy-fuel combustion plant.

7. The method of claim 1, wherein the acid gas is selected from the group consisting of NO, NO₂, SO₂, SO₃, and combinations thereof.

8. The method of claim 1, wherein the stripped flue gas stream has less than about 1 ppm nitrogen oxides.

9. The method of claim 1, wherein the stripped flue gas stream has less than about 1 ppm sulfur oxides.

10. The method of claim 1, wherein the carbon dioxide product stream has less than about 10 ppm oxidant.

11. The method of claim 1, further comprising deoxygenating at a temperature lower than a temperature that produces nitrogen oxides.

12. The method of claim 1, wherein the water scrubber comprises a series of water scrubbers.

13. The method of claim 1, wherein the water scrubber comprises a countercurrent packed bed spray tower.

14. The method of claim 1, further comprising bubbling the flue gas stream into the water scrubber.

15. The method of claim 1, further comprising agitating the water scrubber.

16. The method of claim 1, wherein the flue gas stream is at a pressure between about 30 bar and about 60 bar.

17. The method of claim 1, wherein the flue gas stream is from an amine scrubbing plant.

18. The method of claim 17, further comprising passing the steam to regeneration in the amine scrubbing plant.

19. The method of claim 1, further comprising heating the stripped flue gas stream before deoxygenation with heat from an oxy-fuel combustion plant.

20. The method of claim 1, further comprising creating the flue gas stream in an oxy-fuel combustion system.

21. The method of claim 1, further comprising processing the acid water stream to recover water for use as a portion of the water stream and to produce an acid product stream.

22. The method of claim 21, further comprising neutralizing the acid product stream.

23. The method of claim 1, further comprising controlling the pH of the water stream.

24. The method of claim 1, wherein the flue gas stream is sourced from a coal power plant or a cement plant, the method further comprising filtering out particulates and heavy metals from the flue gas stream before water scrubbing.

25. A method for removing an acid gas from a flue gas stream, the flue gas stream comprising an acid gas and carbon dioxide, the method comprising:
injecting the flue gas stream and an oxidant stream into a water scrubber;
reacting the acid gas and the oxidant such that the oxidant oxidizes the acid gas, generating an acidic water stream and a stripped flue gas stream;
passing the acidic water stream out of the water scrubber;
passing the stripped flue gas stream out of the water scrubber;
passing the stripped flue gas stream out of the water scrubber;
deoxygenating the stripped flue gas stream to produce a carbon dioxide product stream;
cooling the carbon dioxide product stream by trim heating the water stream and by generating steam;
dehydrating the carbon dioxide product stream to produce a dry carbon dioxide product stream and a makeup water stream; and
passing the makeup water stream to the water scrubber as part of the water stream.

26. The method of claim 25, wherein the flue gas stream further comprises a second oxidant.

27. A system for removing an acid gas from a flue gas stream, the flue gas stream comprising an acid gas, an oxidant, and carbon dioxide, the system comprising:
a water scrubber to:
react the acid gas and the oxidant such that the oxidant oxidizes the acid gas to generate an acidic water stream and a stripped flue gas stream;
pass the acid water stream out of the water scrubber;
pass the stripped flue gas stream out of the water scrubber;
a deoxygenation unit to deoxygenate the stripped flue gas stream to produce a carbon dioxide product stream;
a first heat exchanger to cool the carbon dioxide product stream by trim heating the water steam;
a second heat exchanger to further cool the carbon dioxide product stream by creating steam; and
a dehydrator to dehydrate the carbon dioxide product stream to produce a dry carbon dioxide product stream and a makeup water stream and to pass the makeup water stream to the water scrubber as makeup for the water stream.

28. The system of claim 27, further comprising an oxidant production unit to inject an additional oxidant into the water scrubber to react with the acid gas.

29. The system of claim 28, wherein the oxidant is oxygen and the additional oxidant is selected from the group consisting of oxygen, hydrogen peroxide, ozone, NaOCl, and combinations thereof.

30. The system of claim 29, further comprising an oxygen detector to detect oxygen partial pressure in the carbon dioxide stream and to control the addition of the additional oxidant to keep the detected oxygen partial pressure below a limit.

31. The system of claim 27, wherein the dehydrator comprises a molecular sieve.

32. The system of claim 27, wherein the flue gas comprises mercury, mercury oxides, or both, the system further comprising a mercury scrubber to remove the mercury, mercury oxides, or both from the flue gas stream before the water scrubber.

33. The system of claim 27, further comprising a heat exchanger to cool the carbon dioxide product stream before the dehydrator with a cold fluid from an air separation unit or cooling water from an oxy-fuel combustion plant.

34. The system of claim 27, wherein the acid gas is selected from the group consisting of NO, NO₂, SO₂, SO₃, and combinations thereof.

35. The system of claim 27, wherein the stripped flue gas stream has less than about 1 ppm nitrogen oxides.

36. The system of claim 27, wherein the stripped flue gas stream has less than about 1 ppm sulfur oxides.

37. The system of claim 27, wherein the carbon dioxide product stream has less than about 10 ppm oxidant.

38. The system of claim 27, the deoxygenation unit further to operate at a temperature lower than a temperature that produces nitrogen oxides.

39. The system of claim 27, wherein the water scrubber comprises a series of water scrubbers.

40. The system of claim 27, wherein the water scrubber comprises a countercurrent packed bed spray tower.

41. The system of claim 27, wherein the water scrubber comprises a bubbler to disperse the flue gas stream into the water scrubber.

42. The system of claim 27, wherein the water scrubber comprises an agitator to agitate the water stream.

43. The system of claim 27, wherein the flue gas stream is at a pressure between about 30 bar and about 60 bar.

44. The system of claim 27, further comprising an amine scrubber to upgrade carbon dioxide content in the flue gas stream before the water scrubber.

45. The system of claim 44, further comprising a steam regeneration unit in the amine scrubbing plant to receive the steam.

46. The system of claim 27, further comprising an oxy-fuel combustion plant to provide a heating fluid to heat the stripped flue gas stream before the deoxygenation unit.

47. The system of claim 27, further comprising an oxy-fuel combustion plant to create the flue gas stream.

48. The system of claim 27, further comprising an acid removal unit to recover water from the acid water stream and produce an acid product stream.

49. The system of claim 48, further comprising a neutralizer unit to neutralize the acid product stream.

50. The system of claim 27, further comprising a pH controller to control the pH of the water stream.

51. The system of claim 27, wherein the flue gas stream is sourced from a coal power plant or a cement plant, the system further comprising a filter to remove particulates and heavy metals from the flue gas stream before the water scrubber.

52. A system for removing an acid gas from a flue gas stream, the flue gas stream comprising an acid gas and carbon dioxide, the system comprising:
a water scrubber to:
react the acid gas and an oxidant such that the oxidant oxidizes the acid gas to generate an acidic water stream and a stripped flue gas stream;
pass the acid water stream out of the water scrubber;
pass the stripped flue gas stream out of the water scrubber;
a deoxygenation unit to deoxygenate the stripped flue gas stream to produce a carbon dioxide product stream;
a first heat exchanger to cool the carbon dioxide product stream by trim heating the water steam;
a second heat exchanger to further cool the carbon dioxide product stream by creating steam; and
a dehydrator to dehydrate the carbon dioxide product stream to produce a dry carbon dioxide product stream and a makeup water stream and to pass the makeup water stream to the water scrubber as makeup for the water stream.

53. The system of claim 52, wherein the flue gas stream further comprises a second oxidant.
